(19) United States
(12) Patent Application Publication
(10) Pub. No.: US 2022/0406283 A1
(43) Pub. Date: Dec. 22, 2022

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventor: HARUHIKO KISHI, TOKYO (JP)

(21) Appl. No.: 17/756,108

(22) PCT Filed: Nov. 17, 2020
(86) PCT No.: PCT/JP2020/042873

§ 371 Date: May 17, 2022

(30) Foreign Application Priority Data
Nov. 26, 2019 (JP) 2019-212912

(51) Int. Cl. G10H 1/38; G10H 1/00

(52) U.S. Cl. CPC G10H 1/383; G10H 1/0025; G10H 2240/141; G10H 2210/576

(57) ABSTRACT

An information processing apparatus according to the present disclosure includes: an acquisition unit that acquires music information; an extraction unit that extracts a plurality of types of feature amounts from the music information acquired by the acquisition unit; and a generation unit that generates information in which the plurality of types of feature amounts extracted by the extraction unit is associated with predetermined identification information as music feature information to be used as learning data in composition processing using machine learning.

### FIELD

The present disclosure relates to an information processing apparatus, an information processing method, and an information processing program.

### BACKGROUND

With the advancement of artificial intelligence (AI), utilization of computers in the field of art has been advanced. For example, a technology is known in which machine learning is performed on existing music as learning data to generate a model for music generation and a computer is caused to compose new music (for example, Patent Literature 1). In such a technology, it is possible to imitate features of existing music or generate a more natural melody by using a Markov model.

### CITATION LIST

### Patent Literature

Patent Literature 1: U.S. Pat. No. 9,110,817

### SUMMARY

### Technical Problem

According to conventional art, since music information proposed (generated) by AI can be used in composition work, a user can perform composition on the basis of more various viewpoints.

The automatic composition function by AI is set for general users, and the general users can receive automatically created music information only by setting images such as bright and dark. On the other hand, since a producer who creates music often specifically sets features of music such as chord progression and bass progression in the process of creating the music, there has been a demand from the producer to receive provision of music information that matches the features of the music rather than an image.

Therefore, the present disclosure proposes an information processing apparatus, an information processing method, and an information processing program capable of improving convenience of a music creation function by a user.

### Solution to Problem

To solve the above problem, an information processing apparatus according to the present disclosure includes: an acquisition unit that acquires music information; an extraction unit that extracts a plurality of types of feature amounts from the music information acquired by the acquisition unit; and a generation unit that generates information in which the plurality of types of feature amounts extracted by the extraction unit is associated with predetermined identification information as music feature information to be used as learning data in composition processing using machine learning.

### BRIEF DESCRIPTION OF DRAWINGS

FIG. 1 is a conceptual diagram illustrating a flow of information processing according to an embodiment.

FIG. 2 is a diagram illustrating an example of a data configuration of style information according to an embodiment.

FIG. 3 is a diagram illustrating an example of a display screen of a user terminal according to an embodiment.

FIG. 4 is a diagram illustrating an example of a display screen of a user terminal according to an embodiment.

FIG. 5 is a diagram illustrating an example of a display screen of a user terminal according to an embodiment.

FIG. 6 is a diagram illustrating an example of a display screen of a user terminal according to an embodiment.

FIG. 7 is a diagram illustrating an example of a display screen of a user terminal according to an embodiment.

FIG. 8 is a conceptual diagram illustrating a flow of information processing according to an embodiment.

FIG. 9 is a diagram illustrating an example of an information processing system according to an embodiment.

FIG. 10 explains a configuration of a copyrighted work management apparatus according to an embodiment.

FIG. 11 is a diagram illustrating an example of a copyrighted music information storage unit according to an embodiment.

FIG. 12 is a diagram illustrating an example of a music storage unit according to an embodiment.

FIG. 13 is a diagram illustrating an example of a feature information storage unit according to an embodiment.

FIG. 14 is a diagram explaining a configuration of overall information according to an embodiment.

FIG. 15 is a diagram illustrating an example of time-series information constituting music feature information according to an embodiment.

FIG. 16 is a diagram illustrating a configuration example of an information processing apparatus according to an embodiment.

FIG. 17 is a diagram illustrating an example of a user information storage unit according to an embodiment.

FIG. 18 is a diagram illustrating an example of a style information storage unit according to an embodiment.

FIG. 19 is a diagram illustrating an example of an owned information storage unit according to an embodiment.

FIG. 20 is a diagram illustrating an example of a production information storage unit according to an embodiment.

FIG. 21 is a diagram illustrating a configuration example of a user terminal according to an embodiment.

FIG. 22 is a sequence diagram illustrating a procedure of information processing according to an embodiment.

FIG. 23 is a sequence diagram illustrating a procedure of information processing according to an embodiment.

FIG. 24 is a sequence diagram illustrating a procedure of information processing according to an embodiment.

FIG. 25 is a diagram illustrating an example of a conceptual diagram of a configuration of an information processing system.

FIG. 26 is a diagram illustrating an example of a user interface according to an embodiment.

FIG. 27 is a diagram illustrating an example of a user interface according to an embodiment.

FIG. 28 is a hardware configuration diagram illustrating an example of a computer that implements functions of an information processing apparatus, a copyrighted work management apparatus, and a user terminal.

### DESCRIPTION OF EMBODIMENTS

The embodiment of the present disclosure will be described below in detail on the basis of the drawings. Note that the information processing apparatus, the information processing method, the information processing program according to the present application are not limited by the embodiment. In addition, in each embodiment described below, the same parts are designated by the same reference numerals, and duplicate description will be omitted.

The present disclosure will be described in the order of items described below.

1. Embodiment
1-1. Example of the information processing according to the embodiment
1-2. Configuration of the information processing system according to the embodiment
1-3. Configuration of the copyrighted work management apparatus according to the embodiment
1-4. Configuration of the information processing apparatus according to the embodiment
1-5. Configuration of the user terminal according to the embodiment
1-6. Procedure of information processing according to the embodiment
   1-6-1. Processing of generating style information of copyrighted music information
   1-6-2. Processing of generating style information of music information created by producer
   1-6-3. Processing of updating style information
1-7. Conceptual diagram of configuration of the information processing system
   1-7-1. Regarding overall configuration
   1-7-2. Regarding copyrighted music management server apparatus
   1-7-3. Regarding server apparatus
   1-7-4. Regarding music producer app unit

2. Effects according to the present embodiment

3. Other embodiment
3-1. Other configuration example
3-2. Others

4. Hardware configuration

### 1. Embodiment

[1-1. Example of the Information Processing According to the Embodiment]

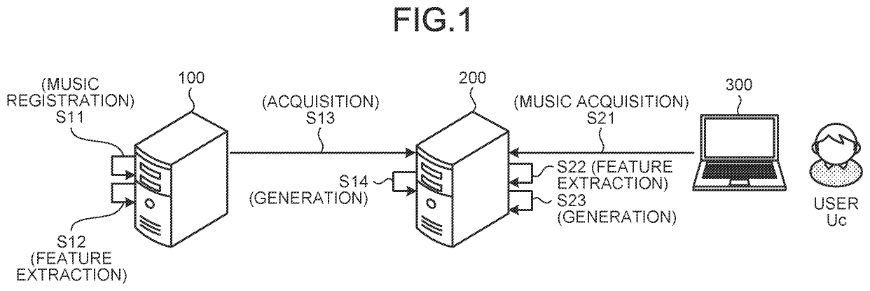

First, an example of information processing according to the present disclosure will be described with reference to FIG. 1. FIG. 1 is a conceptual diagram illustrating a flow of information processing according to the embodiment. The information processing according to the embodiment is executed by a copyrighted work management apparatus 100, an information processing apparatus 200, and a user terminal 300.

In the present embodiment, a case where the information processing apparatus 200 is an information processing apparatus that provides a service related to creation of content (information) as a copyrighted work (also simply referred to as a “service”) will be described as an example. Note that, in the following, music (music content) will be described as an example of the content, but the content is not limited to music, and may be various types of content such as video content such as a movie or character content such as a book (novel or the like). In addition, the music referred to herein is not limited to one completed music (whole), and is a concept including a part of a sound source constituting one song (music) and various music information such as a short sound used for sampling.

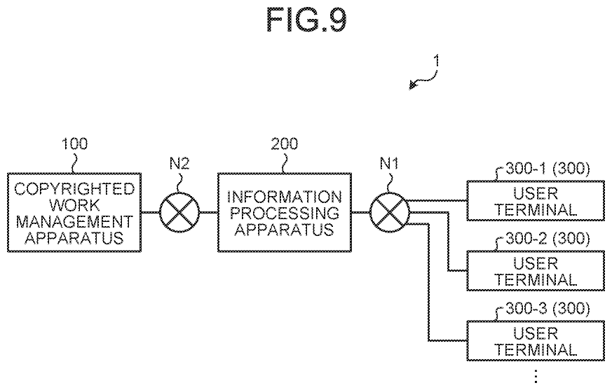

The information processing apparatus 200 communicates with the copyrighted work management apparatus 100 that manages copyrighted music information by using a private network N2 (see FIG. 9). The private network N2 is, for example, a secure virtual private network (VPN) or Internet communication with ID address authentication. The information processing apparatus 200 communicates with the user terminal 300 of a user who uses the service provided by the information processing apparatus 200 by using a network N1 (see FIG. 9) such as the Internet. Note that the number of user terminals 300 is not limited to that illustrated in FIG. 1.

The copyrighted work management apparatus 100 is a server apparatus that registers and manages copyrighted music information. The copyrighted work management apparatus 100 periodically registers copyrighted music information. The copyrighted work management apparatus 100 extracts a plurality of types of feature amounts from the registered copyrighted music information, and transmits the extracted feature amounts to the information processing apparatus 200 via the private network N2.

The user terminal 300 is an information processing terminal such as a personal computer (PC) or a tablet terminal. Various program applications are installed in the user terminal 300. A music creation-related application is installed in the user terminal 300. For example, the user terminal 300 has an automatic composition function by AI added by a plug-in (extended application) to an app such as a DAW that realizes a comprehensive music production environment. For example, the plug-in may take the form of Steinberg's Virtual Studio Technology (VST) (registered trademark), AudioUnits, Avid Audio eXtension (AAX), or the like. In addition, the user terminal 300 is not limited to the DAW, and may use, for example, a mobile app such as iOS.

The user terminal 300 activates and executes the automatic composition function by the DAW and AI, communicates with the information processing apparatus 200 and receives provision of music information composed by the information processing apparatus 200.

The user of the user terminal 300 is any one of a manager who operates and manages the entire system, a composer who creates music, an arranger, a producer such as a studio engineer, and a general user who receives provision of music information via the automatic composition function. In the present embodiment, it is assumed that the user terminal 300 is used by a producer Uc.

The information processing apparatus 200 is a server apparatus that executes information processing related to the automatic composition function by AI of the user terminal 300. For example, the information processing apparatus 200 is a so-called cloud server, executes automatic composition by AI according to instruction information by the user terminal 300, and provides the generated music information to the user terminal 300.

The information processing apparatus 200 performs machine learning to generate a composition model for music generation. For example, the information processing apparatus 200 provides music information automatically composed using a Markov model or the like to the user terminal 300.

The information processing apparatus 200 uses the style information (music feature information) as learning data of the composition model. The style information is information in which a plurality of types of feature amounts such as a chord progression, a melody, and a bass progression extracted from music information as a plurality of types of feature amounts is associated with predetermined identification information, and is used in composition processing using machine learning. The information processing apparatus 200 obtains a plurality of types of feature amounts from the copyrighted music information or the music information created by the producer, and compiles the feature amounts and assigns a style information ID (predetermined identification information) for each piece of music information to generate a plurality of pieces of style information and create a database.

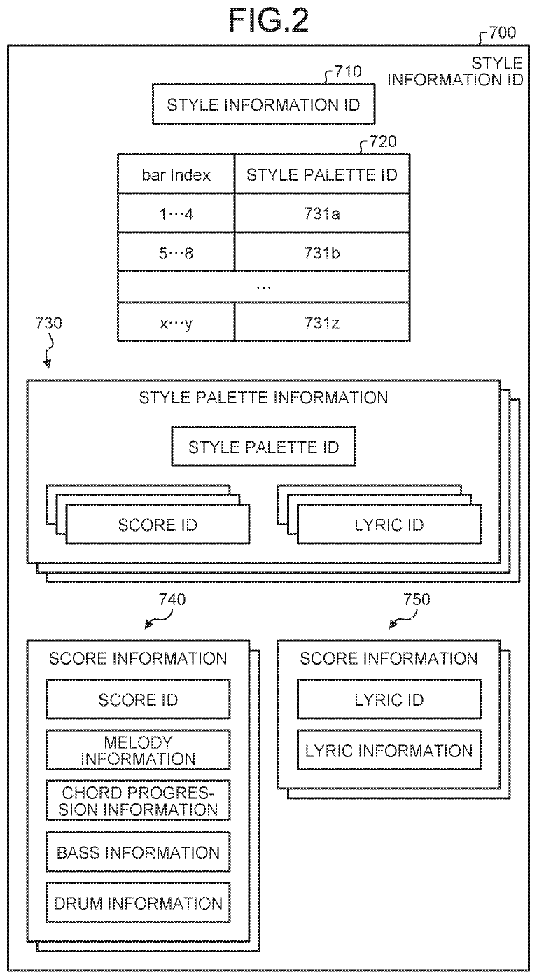

FIG. 2 is a diagram illustrating an example of a data configuration of style information according to the embodiment. The style information includes a style information ID 710, which is identification information of the style information, style palette sequence information 720 (music order information), style palette information 730 (music format information), score information 740, and lyric information 750.

The score information 740 includes a plurality of types of feature amounts extracted from music. The score information 740 includes a score ID, melody information, chord progression information, bass information, and drum information. The score ID is identification information of the score information. The melody information is a melody in a bar having a prescribed length. The chord progression information is information indicating a chord progression in a bar having a prescribed length. The bass information is information indicating a bass sound progression in a bar having a prescribed length. The drum information is information indicating a drum sound progression (pattern or tempo of the drum) in a bar having a prescribed length.

The lyric information 750 includes a lyric ID and lyric information. The lyric ID is identification information of the lyric information. The lyric information is information indicating lyrics in a bar having a prescribed length. The lyric information is, for example, phrases or character keywords which are a source of the lyrics. The information processing apparatus 200 can also perform automatic lyric writing by using a plurality of pieces of lyric information 750 of style information 700.

The style palette information 730 is information in which the score ID of the score information 740 and the lyric ID of the lyric information 750 for the same bar are registered in association with a style palette ID that is identification information of the style palette information.

The style palette sequence information 720 is information indicating the order of the style palette information 730. The style palette sequence information 720 includes a plurality of sets, each set including the style palette ID uniquely indicating the style palette information 730 and a bar index so as to be information for managing the order of the style palette information 730 in music. For example, in the case of the example illustrated in FIG. 2, it is defined that first to fourth bars of music correspond to a style palette ID 731a, fifth to eighth bars correspond to a style palette ID 731b, and x-th to y-th bars correspond to a style palette ID 731z.

The information processing apparatus 200 performs machine learning using the style information 700 as learning data and performs composition processing. Therefore, the information processing apparatus 200 does not learn the music information itself, but learns the style information including the plurality of types of feature amounts such as a chord progression, a melody, a bass progression, and the like extracted from the music information. That is, since the information processing apparatus 200 learns the plurality of feature amounts extracted in advance from the music information, the load of the information processing is small as compared with the double of learning the music information itself, and the music information to the user can be efficiently provided.

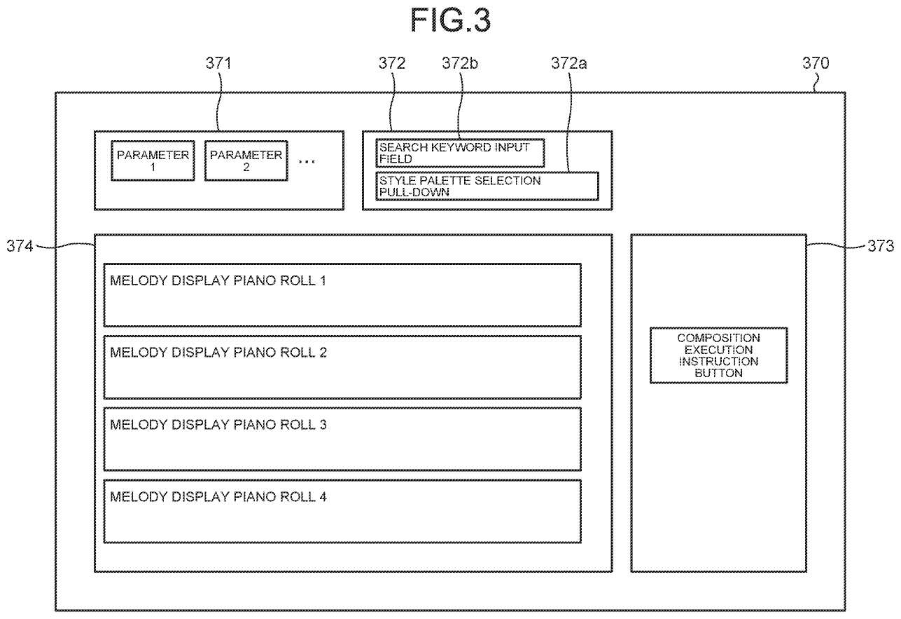

Specifically, a process of music creation by a producer will be described. FIGS. 3 to 7 are diagrams illustrating an example of a display screen of the user terminal 300 according to the embodiment. When the producer activates the automatic composition function on the user terminal 300, a window 370 illustrated in FIG. 3 is displayed on the user terminal 300.

Note that the window 370 includes a composition parameter setting unit 371, a style information display unit 372, a composition control unit 373, and a produced music display editing unit 374. The composition parameter setting unit 371 is a region in which parameters such as a note duration and complexity can be set. The style information display unit 372 is a region in which style information to be used for composition can be selected by keyword input or pull-down selection. The composition control unit 373 is a region in which a composition instruction can be made by selecting a composition execution instruction button. The produced music display editing unit 374 is a region in which a plurality of piano rolls on which melodies and lyrics are displayed is displayed.

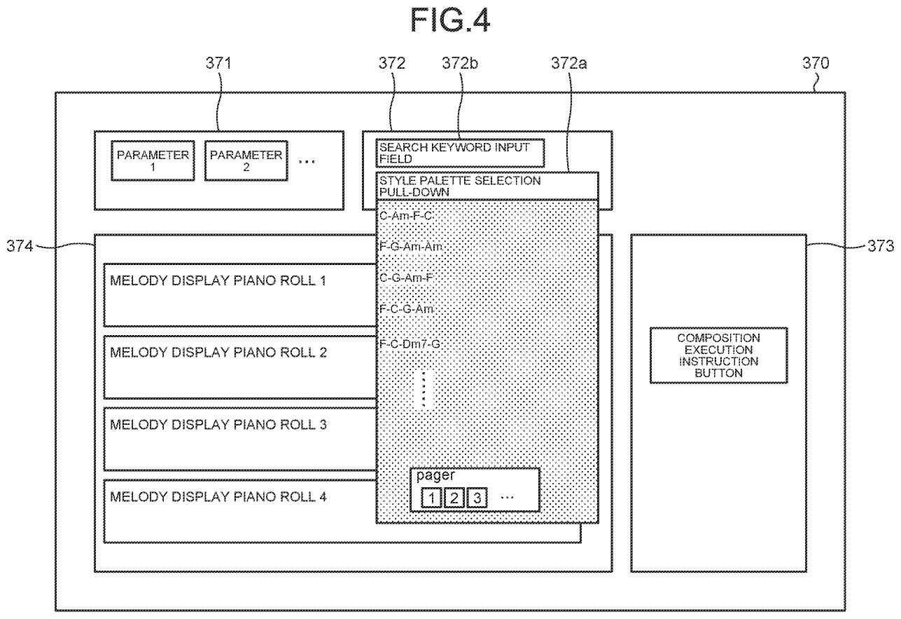

Then, as illustrated in FIG. 4, when a style palette selection pull-down 372a is selected, the chord progression of each style information included in the information processing apparatus 200 is displayed in a list as a candidate.

The chord progression candidates may be displayed in any order such as an alphabetical order, an order in which the number of times of use by the producer is large, an order in which the number of times of use by all users is large, and an order of generation of style information. Regarding the chord progression, all or only a part of the style information included in the information processing apparatus 200 may be displayed. When there are many chord progression candidates, the display region can be selected with a pager. In addition, when the producer inputs a desired chord progression in a search keyword input field 372b, the information processing apparatus 200 may extract style information including the chord progression and display a list of the chord progression information of each piece of the extracted style information in the style palette selection pull-down 372a.

The producer selects a desired chord progression from the chord progressions presented in the style palette selection pull-down 372a and selects the composition execution instruction button. Thus, the information processing apparatus 200 extracts the style information having the selected chord progression, performs machine learning using the extracted style information 700 as learning data, and performs the composition processing. Then, the information processing apparatus 200 provides music information to the user terminal 300. As a result, the producer can receive the provision of the music information generated in accordance with the chord progression only by selecting the desired chord progression from the chord progressions presented in the style palette selection pull-down 372a.

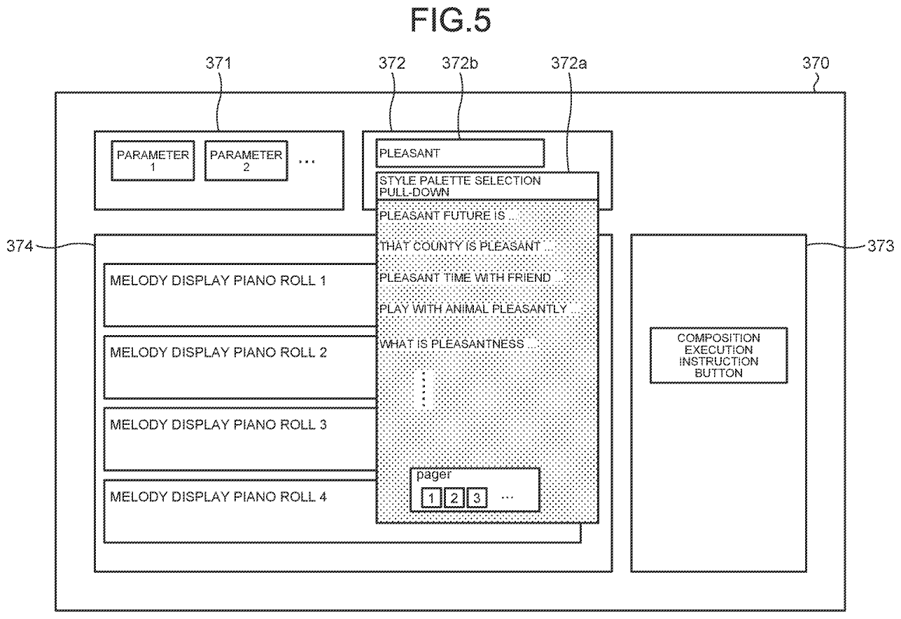

In addition, since the style information 700 includes the lyric information as the feature amount, only by inputting desired lyrics, the producer can receive the presentation of the style information that matches the lyrics. Specifically, as illustrated in FIG. 5, when the producer inputs desired lyrics in the search keyword input field 372b, the information processing apparatus 200 may extract style information having the lyrics or lyrics similar to the lyrics and display a list of the lyric information of each piece of the extracted style information in the style palette selection pull-down 372a.

The producer selects desired lyric information from the lyric information presented in the style palette selection pull-down 372a and selects the composition execution instruction button. Thus, the information processing apparatus 200 extracts the style information having the selected lyric information, performs machine learning using the extracted style information 700 as learning data, performs the composition processing, and provides the music information to the user terminal 300.

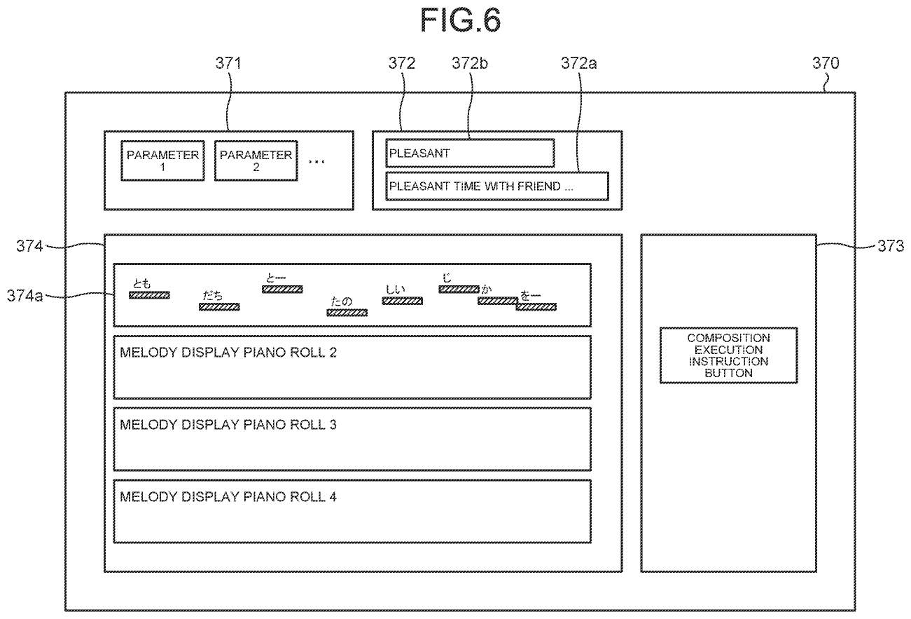

As a result, the producer can receive the provision of the music information generated in accordance with the lyrics only by selecting the desired lyrics from the lyrics presented in the style palette selection pull-down 372a. At this time, the information processing apparatus 200 may automatically generate lyrics in accordance with the generated music and provide the user terminal 300 with music information in which the melody is associated with the lyrics. In this case, on the screen of the user terminal 300, the melody and the lyrics corresponding to the melody are displayed on a melody display piano roll 374a of FIG. 6.

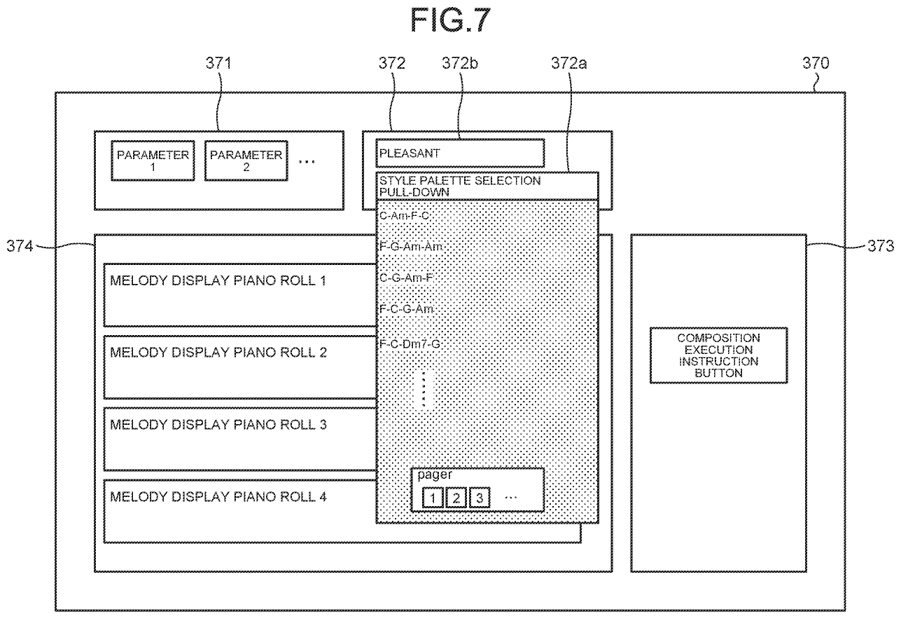

In addition, in a case where the producer inputs the lyrics, as illustrated in FIG. 7, the user terminal 300 may display a list of candidates of the chord progression of the style information presented from the information processing apparatus 200 and support the producer's music creation.

As described above, the information processing apparatus 200 generates the style information having the plurality of types of feature amounts of the music information as a learning data set of the composition model, and causes the composition model to learn the style information. Thus, the information processing apparatus 200 provides the producer with the music information composed in accordance with the features of the music. Hereinafter, a flow of style information generation processing in the information processing according to the present embodiment will be described with reference to FIG. 1.

As illustrated in FIG. 1, when the copyrighted music information is newly registered (Step S11), the copyrighted work management apparatus 100 extracts a plurality of types of feature amounts from each piece of newly registered copyrighted music information (Step S12). At this time, the copyrighted work management apparatus 100 extracts the feature amounts using, for example, the twelve-tone analysis technique. Then, the information processing apparatus 200 acquires a plurality of types of feature amounts from the copyrighted work management apparatus 100 (Step S13), compiles the feature amounts and assigns a style information ID for each piece of music information to generate the style information corresponding to each piece of music information (Step S14).

In addition, when a new music is created through the input of the feature amounts such as a chord progression, a melody, a bass progression, and the like by the operation by the producer Uc of the user terminal 300, the information processing apparatus 200 acquires music information including each feature amount (Step S21). Then, the information processing apparatus 200 extracts the feature amounts such as a chord progression, a melody, a bass progression, and the like from the acquired music information (Step S22). Then, the information processing apparatus 200 generates the style information corresponding to each piece of music information by compiling the feature amounts and assigning the style information ID for each piece of music information (Step S23). The information processing apparatus 200 generates a plurality of pieces of style information 700 by performing the processing illustrated in FIG. 1 and creates a database.

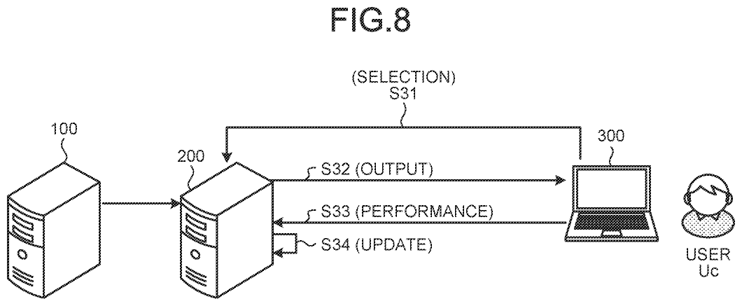

Then, in the information processing according to the present embodiment, the style information can be updated. FIG. 8 is a conceptual diagram illustrating a flow of information processing according to the embodiment. As illustrated in FIG. 8, while the producer Uc is creating music, when the producer Uc selects the style information (Step S31), the information processing apparatus 200 learns the style information to perform composition processing, and outputs the music information to the user terminal 300 (Step S32). The user Uc further performs a performance on the basis of the provided music information. When receiving the performance information (Step S33), the information processing apparatus 200 adds the performance information to the style information used for composition and updates the style information (Step S34).

As described above, in the information processing according to the present embodiment, the used style information is updated according to the creation of the music by the producer Uc. Thus, the information processing apparatus 200 can bring the style information closer to the music creation style of the producer Uc, and compose and provide the music information that matches the style of the producer Uc.

The overview of the overall flow of the information processing according to the present embodiment has been described above. In FIG. 9 and subsequent drawings, a configuration of an information processing system 1 including the copyrighted work management apparatus 100, the information processing apparatus 200, and the user terminal 300 will be described, and details of various processing will be described in order.

[1-2. Configuration of the Information Processing System According to the Embodiment]

FIG. 9 is a diagram illustrating an example of the information processing system 1 according to the embodiment. As illustrated in FIG. 6, the information processing system 1 includes user terminals 300-1 to 300-3, the information processing apparatus 200, and the copyrighted work management apparatus 100. The information processing system 1 functions as a copyrighted work management system or a learning model information management system. In the example of FIG. 9, three user terminals 300-1 to 300-3 are illustrated, but are referred to as the user terminal 300 when described without particular distinction.

The information processing apparatus 200 and the user terminal 300 are communicably connected to each other by wire or wirelessly via the network N1. In addition, the information processing apparatus 200 and the copyrighted work management apparatus 100 are communicably connected to each other by wire or wirelessly via the private network N2.

The copyrighted work management apparatus 100 manages copyrighted music information. The copyrighted work management apparatus 100 periodically registers copyrighted music information. The copyrighted work management apparatus 100 extracts a plurality of types of feature amounts from the registered copyrighted music information, and transmits the extracted feature amounts to the information processing apparatus 200.

The user terminal 300 transmits the music information created by the producer to the information processing apparatus 200 and, when the automatic composition function is activated, receives the provision of the music information composed by the information processing apparatus 200.

The information processing apparatus 200 generates the style information that is learning data from the copyrighted music information or the music information created by the producer, and performs machine learning to generate the composition model. The information processing apparatus 200 provides the music information automatically composed using the generated model to the user terminal 300.

[1-3. Configuration of the Copyrighted Work Management Apparatus According to the Embodiment]

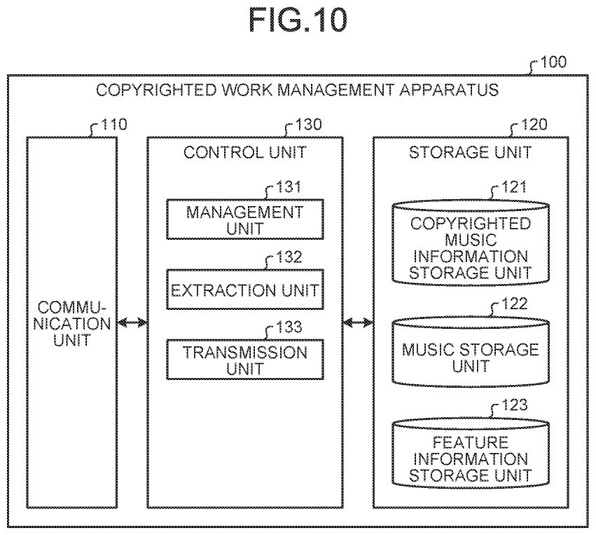

Next, a configuration of the copyrighted work management apparatus 100 illustrated in FIG. 9 will be described with reference to FIG. 10. FIG. 10 is a diagram illustrating a configuration example of the copyrighted work management apparatus 100 according to the embodiment. As illustrated in FIG. 10, the copyrighted work management apparatus 100 includes a communication unit 110, a storage unit 120, and a control unit 130.

The communication unit 110 is realized by, for example, a network interface card (NIC) or the like. The communication unit 110 is connected to the private network N2 by wire or wirelessly, and transmits and receives information to and from the information processing apparatus 200 via the private network N2.

The storage unit 120 is realized by, for example, a semiconductor memory element such as a random access memory (RAM) or a flash memory, or a storage apparatus such as a hard disk or an optical disk. The storage unit 120 stores various data used for information processing. The storage unit 120 includes a copyrighted music information storage unit 121, a music storage unit 122, and a feature information storage unit 123.

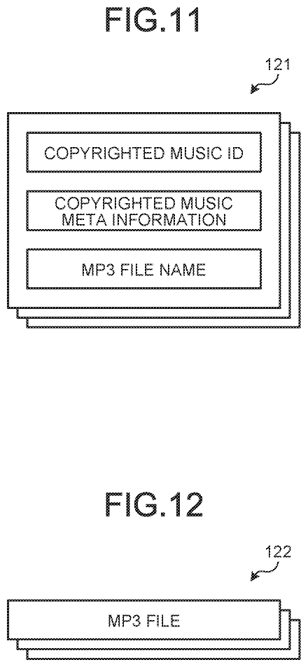

The copyrighted music information storage unit 121 stores information regarding copyrighted music that is a copyrighted work produced in the past. FIG. 11 is a diagram illustrating an example of the copyrighted music information storage unit 121 according to the embodiment.

As illustrated in FIG. 11, a copyrighted music ID, copyrighted music meta information, and an MP3 file name are stored in the copyrighted music information storage unit 121. The copyrighted music ID is, for example, identification information for uniquely specifying copyrighted music such as of the Beatles, Michael Jackson, or the like. The copyrighted music meta information is, for example, additional information regarding the copyrighted music such as the title of copyrighted music, the artist name, the album name, the release date, the genre, the mood, and the lyrics. The MP3 file name is a file name for specifying the MP3 file of the copyrighted music.

The music storage unit 122 stores the music information of the copyrighted music. FIG. 12 is a diagram illustrating an example of the music storage unit 122 according to the embodiment. As illustrated in FIG. 12, the music storage unit 122 stores an MP3 file of each copyrighted music. The MP3 file can be specified by the MP3 file name stored in the copyrighted music information storage unit 121.

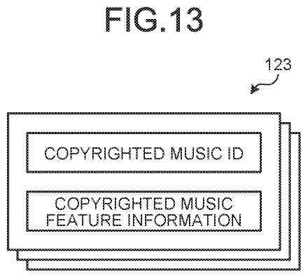

The feature information storage unit 123 stores a plurality of types of feature amounts of copyrighted music. FIG. 13 is a diagram illustrating an example of the feature information storage unit 123 according to the embodiment. As illustrated in FIG. 13, in the feature information storage unit 123, the copyrighted music feature amount is stored in association with the copyrighted music ID. The copyrighted music feature information includes overall information indicating a feature of the entire copyrighted music and time-series information indicating a feature changing in time series.

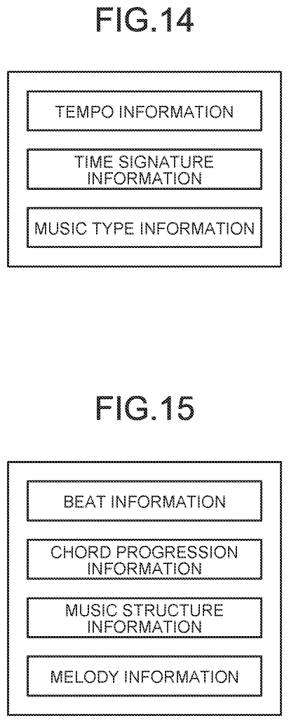

FIG. 14 is a diagram illustrating an example of the overall information according to the embodiment. As illustrated in FIG. 14, the overall information includes, for example, tempo information, time signature information, and music type information such as genre and mood. The music type information is, for example, information such as an automatic channel of the twelve-tone analysis technique.

FIG. 15 is a diagram illustrating an example of time-series information constituting copyrighted music feature information according to the embodiment. As illustrated in FIG. 15, the time-series information includes, for example, beat information, chord progression information, music structure information, and melody information. The beat information includes, for example, time position information of each beat and time position information of each bar, such as a metronome. The chord progression information is information of the time-series progression of an accompaniment chord according to the flow of music, for example, information indicating the progression of a chord such as “C-F-Am-G7”. The music structure information is information such as “1st verse-2nd verse-Chorus-1st verse-Chorus” that is the structure of the overall music. The melody information includes, for example, information of a melody line analogized from audio information of music.

Referring back to FIG. 10, the description will be continued. The control unit 130 is realized by, for example, a central processing unit (CPU), a micro processing unit (MPU), or the like executing a program stored inside the user terminal 300 using a random access memory (RAM) or the like as a work area. In addition, the control unit 130 is a controller and may be realized by, for example, an integrated circuit such as an application specific integrated circuit (ASIC) or a field programmable gate array (FPGA).

The control unit 130 includes a management unit 131, an extraction unit 132, and a transmission unit 133, and realizes or executes a function or operation of information processing described below.

The management unit 131 manages various information related to the copyrighted work management apparatus 100. For example, the management unit 131 stores various information in the storage unit 120, and appropriately updates the stored information. Specifically, the management unit 131 stores new copyrighted music in the copyrighted music information storage unit 121 and updates the information regarding the new copyrighted music.

The extraction unit 132 extracts a plurality of types of feature amounts from the copyrighted music information. The extraction unit 132 acquires periodically registered copyrighted music information at a preset timing, and extracts the chord progression information, the beat information, the melody information, and the drum information as feature amounts from the acquired copyrighted music information. The extraction unit 132 extracts the music feature amount of the MP3 file of each copyrighted music with respect to each newly registered copyrighted music, and obtains the feature information. The extraction unit 132 extracts various feature amounts from the music information using, for example, the twelve-tone analysis technique, and registers the extracted feature amounts as the copyrighted music feature information in the feature information storage unit 123.

The extraction unit 132 receives a copyrighted music extraction instruction from a manager terminal (not illustrated) used by a system manager via the information processing apparatus 200 to perform feature amount extraction processing with respect to the copyrighted music information. Alternatively, the extraction unit 132 performs the feature amount extraction processing with respect to the copyrighted music information by receiving the copyrighted music extraction instruction from the information processing apparatus 200.

The transmission unit 133 transmits a plurality of types of feature amounts of the copyrighted music information extracted by the extraction unit 132 to the information processing apparatus 200 together with, for example, information regarding the copyrighted music information such as the music structure information, the copyrighted music meta information, or the like.

[1-4. Configuration of the Information Processing Apparatus According to the Embodiment]

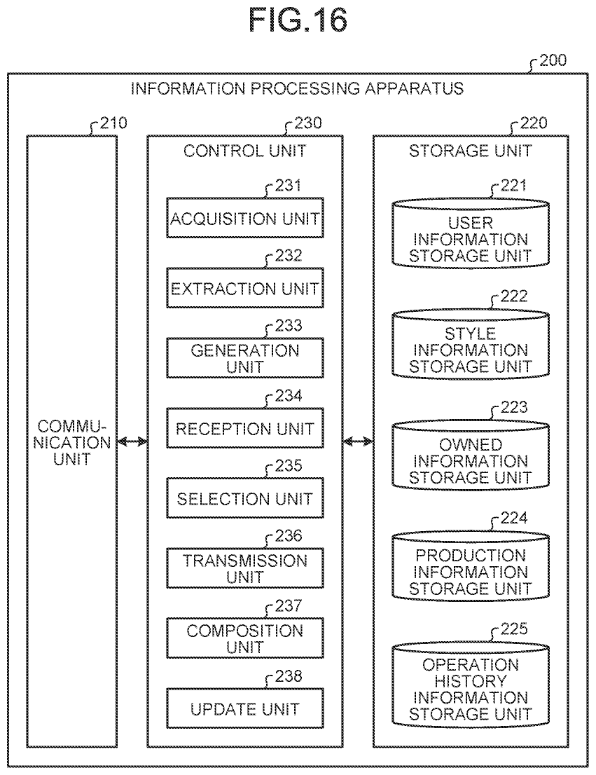

Next, a configuration of the information processing apparatus 200 illustrated in FIG. 9 will be described with reference to FIG. 16. FIG. 16 is a diagram illustrating a configuration example of the information processing apparatus 200 according to the embodiment. As illustrated in FIG. 16, the information processing apparatus 200 includes a communication unit 210, a storage unit 220, and a control unit 230. Note that the information processing apparatus 200 may include an input unit (for example, a keyboard, a mouse, or the like) that receives various operations from a manager or the like who manages the information processing apparatus 200, and a display unit (for example, a liquid crystal display or the like) for displaying various information.

The communication unit 210 is realized by, for example, an NIC or the like. The communication unit 210 is connected to the network N1 and the private network N2 by wire or wirelessly, and transmits and receives information to and from the user terminal 300, the production management apparatus 100, or the like via the network N or the private network N2.

The storage unit 220 is realized by, for example, a semiconductor memory element such as a RAM or a flash memory, or a storage apparatus such as a hard disk or an optical disk. The storage unit 220 stores various data used for information processing.

As illustrated in FIG. 16, the storage unit 220 includes a user information storage unit 221, a style information storage unit 222, an owned information storage unit 223, a production information storage unit 224, and an operation history information storage unit 225.

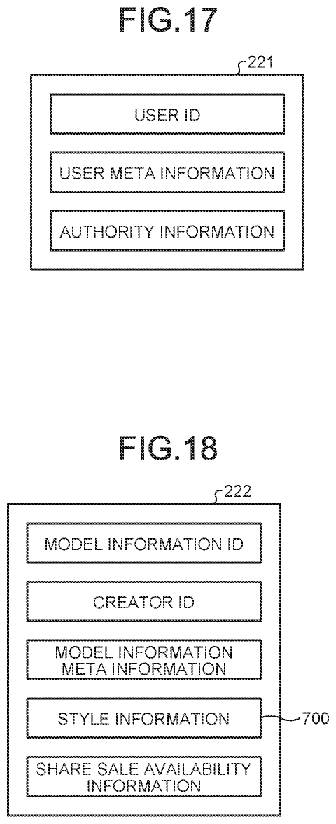

The user information storage unit 221 stores various information regarding the user (user information). FIG. 17 is a diagram illustrating an example of the user information storage unit 221 according to the embodiment.

The user information storage unit 221 stores user information including a user ID, user meta information, and authority information. The user information storage unit 221 stores the user meta information or the authority information corresponding to each user ID in association with each user ID.

The user ID indicates identification information for uniquely specifying the user. For example, the user ID indicates identification information for uniquely specifying a user such as a producer, a general user, a system manager, or the like. The user meta information is, for example, additional information of the user such as a name and an address of the user. As the authority information, for example, values for identifying the authority such as system manager authority information, producer authority information, and general user authority information are stored. Note that the user information storage unit 221 is not limited to the above, and may store various types of information depending on the purpose. Various information related to the user may be stored in the user meta information. For example, in a case where the user is a natural person, demographic attribute information, psychographic attribute information such as gender and age of the user, and the like may be stored in the user meta information.

The style information storage unit 222 stores information regarding the composition model. FIG. 18 is a diagram illustrating an example of the style information storage unit 222 according to the embodiment.

The style information storage unit 222 stores learning model information including a model information ID, a creator ID, model information meta information, the style information 700, a copyrighted work ID, and share availability information. The style information storage unit 222 stores the creator ID, the model information meta information, the style information, the copyrighted work ID, and the share availability information corresponding to each model information ID in association with each model information ID.

The model information ID indicates identification information for uniquely specifying the composition model information. The creator ID indicates identification information for uniquely specifying the creator of the corresponding composition model information. For example, the creator ID indicates identification information for uniquely specifying a user such as a system manager, a producer, a general user, or the like.

The model information meta information is, for example, information indicating a feature of a copyrighted work to be learned. The learning model information meta information is information such as tempo of music, genre, atmosphere such as light and dark, structure of music such as 1st verse, 2nd verse, and chorus, chord progression, scale, and a church mode.

The style information 700 is learning data of a composition model generated by a generation unit 233 (described below) included in the information processing apparatus 200. As described in FIG. 2, the style information is information in which a plurality of types of feature amounts such as a chord progression, a melody, and a bass progression extracted from music information is associated with predetermined identification information.

The share availability information indicates, for example, whether the corresponding learning model can be shared. As the share availability information, for example, a value for specifying and identifying whether or not the corresponding learning model can be shared is stored.

Note that the style information storage unit 222 is not limited to the above, and may store various types of information depending on the purpose. For example, the composition model information meta information may store various types of additional information related to the composition model, such as information related to a date and time when the composition model is created.

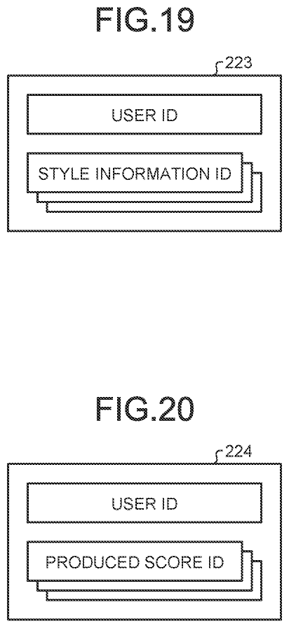

The owned information storage unit 223 stores various information regarding the style information selected at the time of creating the music by the producer who creates the music. FIG. 19 is a diagram illustrating an example of the owned information storage unit 223 according to the embodiment. The owned information storage unit 223 stores the user ID of the producer who creates the music and the style information ID selected by the producer in association with each other.

The production information storage unit 224 stores various information regarding the produced music. FIG. 20 is a diagram illustrating an example of the production information storage unit 224 according to the embodiment. As illustrated in FIG. 20, the production information storage unit 224 stores the user ID of the producer who created the music and the score ID created by the producer in association with each other.

The operation history information storage unit 225 stores operation history information by the producer with respect to the user terminal 300. The operation history information storage unit 225 stores the operation history corresponding to each user ID in association with each user ID. The operation history information indicates an operation history of the producer. For example, the operation history information may include various information regarding the operation of the producer, such as the content of the operation performed by the producer, the date and time when the operation was performed, or the like. Examples of the operation include selection of style information presented from the information processing apparatus 200, selection of a composition execution instruction button, and reproduction and editing of music information received from the information processing apparatus 200.

Referring back to FIG. 16, the description will be continued. The control unit 230 is realized by, for example, a CPU, an MPU, or the like executing a program (for example, the information processing program according to the present embodiment) stored in the information processing apparatus 200 using a RAM or the like as a work area. In addition, the control unit 130 is a controller and may be realized by, for example, an integrated circuit such as an ASIC or an FPGA.

The control unit 230 includes an acquisition unit 231, an extraction unit 232, the generation unit 233, a reception unit 234, a selection unit 235, a transmission unit 236, a composition unit 237, and an update unit 238, and realizes or executes a function or operation of information processing described below.

The acquisition unit 231 acquires the music information. The acquisition unit 231 communicates with the user terminal 300 via the network N1 to acquire the music information created by the producer. The music information is created by the producer using a music creation-related application installed in the user terminal 300, that is, the automatic composition function, and includes feature amounts related to music such as a chord progression, a melody, a bass progression, and a drum sound progression. In addition, the acquisition unit 231 communicates with the copyrighted work management apparatus 100 via the private network N2 and receives the plurality of types of feature amounts of the copyrighted music information extracted by the extraction unit 132 of the copyrighted work management apparatus 100 together with the information regarding the copyrighted music information. That is, the acquisition unit 231 receives the copyrighted music feature information for each newly registered copyrighted music from the copyrighted work management apparatus 100 via the private network N2.

The extraction unit 232 extracts a plurality of types of feature amounts from the music information. The extraction unit 132 extracts chord progression information, beat information, melody information, and drum information as feature amounts from the music information created by the producer. The extraction unit 232 extracts various feature amounts from the music information using, for example, the twelve-tone analysis technique.

The generation unit 233 generates the style information in which the plurality of types of feature amounts extracted by the extraction unit 232 is associated with the style information ID as the learning data in the composition processing. The generation unit 233 registers the style information ID of the style information 700 and the user ID of the producer in association with each other in the production information storage unit 224 regarding the music information created by the producer. The generation unit 233 may associate the copyrighted music ID with the style ID of the style information 700 regarding the music information registered in the copyrighted work management apparatus 100.

The reception unit 234 receives various information transmitted from the user terminal 300. For example, the reception unit 234 receives information regarding the producer who uses the automatic composition function in the user terminal 300 and information regarding the style information selected by the producer. In addition, the reception unit 234 can also receive registration of music to be linked with the style information 700, editing of the style information, or the like.

When the automatic composition function is activated in the user terminal 300, the selection unit 235 selects all or part of the style information.

The transmission unit 236 transmits the presentation information of the style information selected by the selection unit 235 to the user terminal 300. Thus, in the style palette selection pull-down 372a of the user terminal 300, a list of chord progression or lyric information of each style information is displayed as a candidate. Then, upon receiving instruction information giving an instruction on selection of any of the presented style information from the user terminal 300, the selection unit 235 selects the selected style information from the style information storage unit 222.

The composition unit 237 composes music information using machine learning on the basis of the style information selected by the selection unit 235, and transmits the composed music information to the user terminal 300. The composition unit 237 may compose music using various existing music generation algorithms. For example, the composition unit 237 may use a music generation algorithm using a Markov chain or may use a music generation algorithm using deep learning. In addition, the composition unit 237 may generate a plurality of pieces of music information with respect to the instruction information transmitted from the user terminal 300. Thus, the producer can receive a plurality of proposals from the composition unit 237, and thus can proceed with composition work using more various information.

In a case where the performance information based on the music information composed by the composition unit 237 is received from the user terminal 300, the update unit 238 adds the performance information to the selected style information to update the selected style information.

[1-5. Configuration of the User Terminal According to the Embodiment]

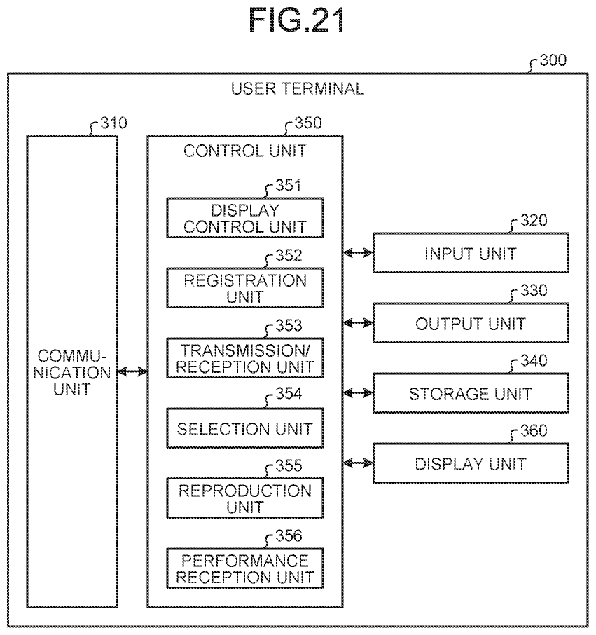

Next, a configuration of the user terminal 300 illustrated in FIG. 9 will be described with reference to FIG. 21. FIG. 21 is a diagram illustrating a configuration example of the user terminal 300 according to the embodiment. As illustrated in FIG. 21, the user terminal 300 includes a communication unit 310, an input unit 320, an output unit 330, a storage unit 340, a control unit 350, and a display unit 360.

The communication unit 310 is realized by, for example, an NIC, a communication circuit, or the like. The communication unit 310 is connected to the network N1 by wire or wirelessly, and transmits and receives information to and from another apparatus or the like such as the information processing apparatus 200, another terminal apparatus, or the like via the network N1.

Various operations are input to the input unit 320 from the user. The input unit 320 includes a keyboard and a mouse connected to the user terminal 3000. The input unit 320 receives an input from the user. The input unit 320 receives the user's input using a keyboard or a mouse. The input unit 320 may have a function of detecting a voice. In this case, the input unit 320 may include a microphone that detects a voice.

Various information may be input to the input unit 320 via the display unit 360. In this case, the input unit 320 may have a touch panel capable of realizing functions equivalent to those of a keyboard and a mouse. In this case, the input unit 12 receives various operations from the user via the display screen by a function of a touch panel realized by various sensors. Note that, as a method of detecting the user's operation by the input unit 320, a capacitance method is mainly adopted in the tablet terminal, but any method may be adopted as long as the user's operation can be detected and the function of the touch panel can be realized, such as a resistive membrane method, a surface acoustic wave method, an infrared method, and an electromagnetic induction method, which are other detection methods. In addition, the user terminal 300 may include an input unit that also receives an operation by a button or the like.

The output unit 330 outputs various information. The output unit 330 includes a speaker that outputs a sound.

The storage unit 340 is realized by, for example, a semiconductor memory element such as a RAM or a flash memory, or a storage apparatus such as a hard disk or an optical disk. The storage unit 340 stores various information used for display of information.

The control unit 350 is realized by, for example, a CPU, an MPU, or the like executing a program stored in the user terminal 300 using a RAM or the like as a work area. In addition, the control unit 350 is a controller and may be realized by, for example, an integrated circuit such as an ASIC or an FPGA. The control unit 350 includes a display control unit 351, a registration unit 352, a transmission/reception unit 353, a selection unit 354, a reproduction unit 355, and a performance reception unit 356.

The display control unit 351 controls various displays with respect to the display unit 360. The display control unit 351 controls display of the display unit 360. The display control unit 351 controls display of the display unit 360 on the basis of the information received from the information processing apparatus 200. The display control unit 351 controls display of the display unit 360 on the basis of information generated by processing by each component of the control unit 350. The display control unit 351 may control the display of the display unit 360 with an application that displays an image.

The display control unit 351 causes the display unit 360 to display the window 370 (see FIGS. 3 to 7) or the like using the application of the automatic composition function by the DAW and AI. In addition, when receiving the presentation information of the style information from the information processing apparatus 200, the display control unit 351 displays the chord progression and the lyrics of the presented style information in the style palette selection pull-down 372a (see FIG. 4) of the window 370. In addition, when receiving the music information and the lyric information generated by the information processing apparatus 200, the display control unit 351 displays the melody and the lyrics corresponding to the melody on the melody display piano roll 374a (see FIG. 7) of the window 370.

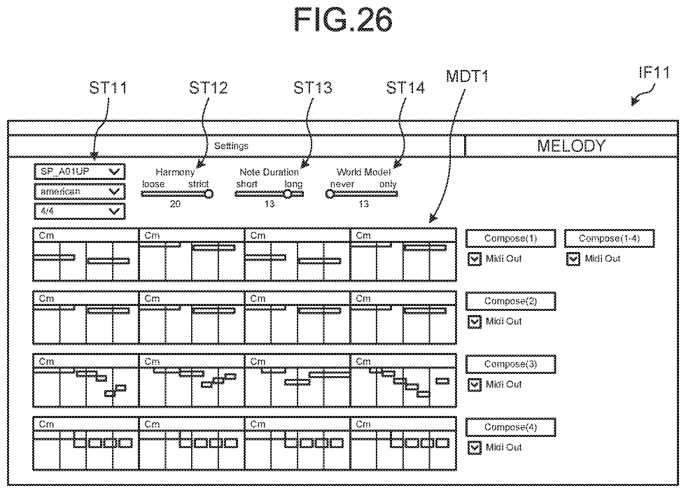

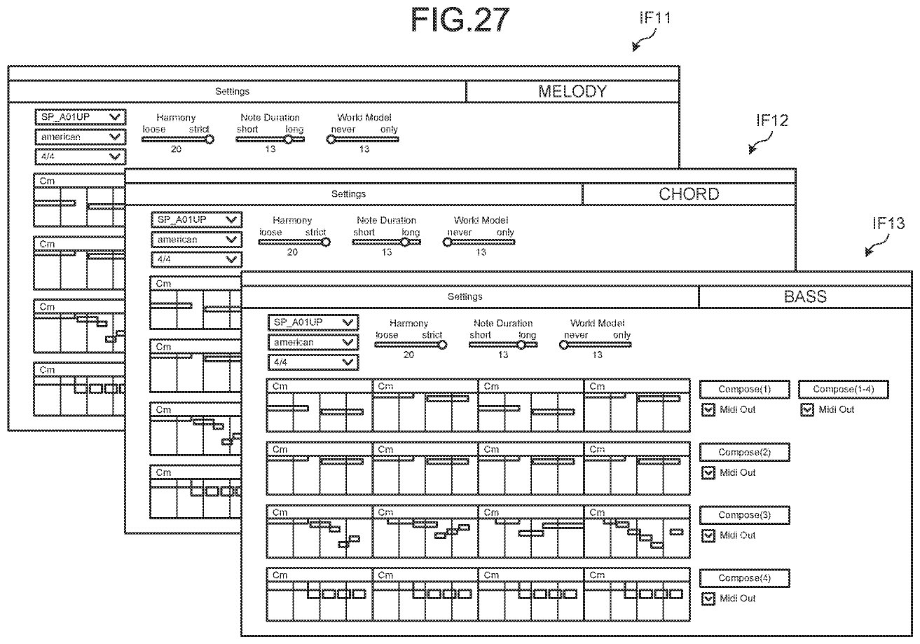

The registration unit 352 receives registration of various information. For example, the registration unit 352 receives registration of the drum pattern, the chord progression, and the melody set by the user at the time of activation of the DAW or the like. For example, the drum pattern, the chord progression, and the melody are registered via an app that displays images IM11, IM21, IM31, and IM41 (FIGS. 26 and 27).

The transmission/reception unit 353 communicates with the information processing apparatus 200, and transmits and receives various information. The transmission/reception unit 353 transmits the music information including the drum pattern, the chord progression, and the melody received by the registration unit 352 to the information processing apparatus 200. In addition, when the automatic composition function is activated, the transmission/reception unit 353 receives the presentation information of the style information transmitted from the information processing apparatus 200. The transmission/reception unit 353 transmits instruction information giving an instruction on selection of the style information to the information processing apparatus 200. Then, the transmission/reception unit 353 receives the music information and the lyric information generated by the information processing apparatus 200. In addition, the transmission/reception unit 353 transmits performance information regarding a performance received by the user terminal 300 to the information processing apparatus 200.

The selection unit 354 selects any of the style information presented from the information processing apparatus 200. For example, any chord progression among the chord progressions displayed in the style palette selection pull-down 372a (see FIG. 4) of the window 370 is selected by the operation of the input unit 320 by the user. Thus, the selection unit 354 transmits the instruction information for selecting the style information corresponding to the selected chord progression from the transmission/reception unit 353 to the information processing apparatus 200.

The reproduction unit 355 reproduces the music information generated by the information processing apparatus 200. Specifically, the reproduction unit 255 sets arbitrary instrument information for each of the melody, the chord, and the bass sound included in music data, and reproduces each piece of data. Note that the reproduction unit 255 may reproduce a combination of each of the melody, the chord, and the bass sound.

The performance reception unit 356 receives a performance by the producer when the producer performs the performance together with composition using the automatic composition function. For example, the performance reception unit 356 receives performance information to be performed in accordance with reproduction of music information generated by the information processing apparatus 200 by the automatic composition function.

The display unit 360 displays various information. The display unit 360 is realized by, for example, a liquid crystal display, an organic electro-luminescence (EL) display, or the like. The display unit 360 displays various information in accordance with control by the display control unit 351. The display unit 360 can also display information such as an image provided from the information processing apparatus 200.

[1-6. Procedure of Information Processing According to the Embodiment]

[1-6-1. Processing of Generating Style Information of Copyrighted Music Information]

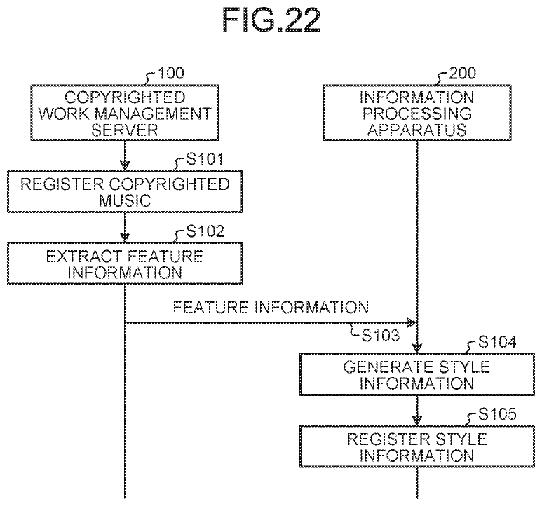

Next, a procedure of various information processing according to the embodiment will be described with reference to FIG. 22. First, as one piece of the information processing according to the present embodiment, automatic generation processing of style information regarding the copyrighted music information will be described. FIG. 22 is a sequence diagram illustrating a procedure of information processing according to the embodiment.

As illustrated in FIG. 22, when the copyrighted music information is newly registered (Step S101), the copyrighted work management apparatus 100 extracts a plurality of types of feature amounts from each piece of newly registered copyrighted music information (Step S102). At this time, the copyrighted work management apparatus 100 extracts the feature amounts using, for example, the twelve-tone analysis technique. Then, the copyrighted work management apparatus 100 transmits the copyrighted music feature information including the plurality of types of feature amounts extracted from the copyrighted music information and the information regarding the copyrighted music information to the information processing apparatus 200 via the private network N2 (Step S103).

The information processing apparatus 200 automatically creates the style information 700 on the basis of the received copyrighted music feature information (Step S104). The information processing apparatus 200 can generate the score information 740 from, for example, beat information, chord progression information, and melody information of the copyrighted music feature information. The information processing apparatus 200 can generate the lyric information 750 from, for example, the lyric information of the copyrighted music meta information.

For example, the information processing apparatus 200 can bundle similar chord progressions of chord information from the pieces of the score information 740 and lyric information 750 to generate the style palette information 730. The similar chord progression is, for example, an identical chord progression. Alternatively, the similar chord progression may be such that each chord is classified into Tonic (T), Sub-dominat (S), and Dominat (D) and the sequences of T, S, and D are the same. Note that in the case of C major and A minor, T is C/Em/Am, S is F and Dm, and D is G and Dm7-5. Then, since both chord progressions C-D-G-C and Em-Dm-Bm7-5-Am are T-S-D-T, they can be considered as the same chord progression. In addition, regarding the similar chord progression, the similar chord progression can be classified, for example, on the basis of machine learning or deep learning, instead of using music theory.

In addition, the information processing apparatus 200 may independently register the automatically generated style palette information 730 in the style palette sequence information 720. The information processing apparatus 200 may generate and register the style palette sequence information 720 in which a plurality of pieces of style palette information 730 is arranged. When arranging the plurality of pieces of style palette information 730, the information processing apparatus 200 can arrange the style palette information 730 with reference to the music structure information.

Subsequently, the information processing apparatus 200 registers the generated style information in association with the identification information of the copyrighted music information (Step S105), and stores the style information in the style information storage unit 222.

[1-6-2. Processing of Generating Style Information of Music Information Created by Producer]

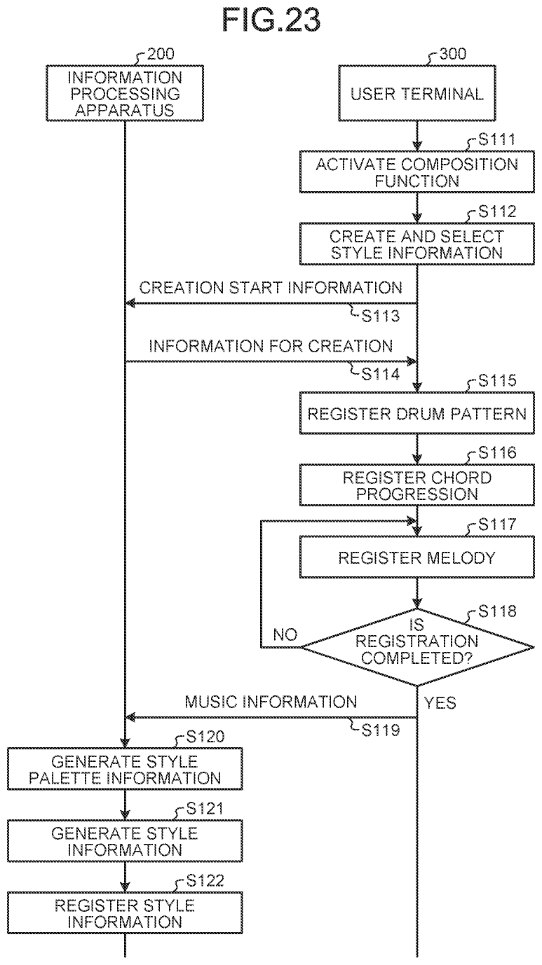

The style information can also be generated with respect to music information created by the producer. Therefore, the processing of generating the style information regarding the music information created by the producer will be described with reference to FIG. 23. FIG. 23 is a sequence diagram illustrating a procedure of information processing according to the embodiment.

As illustrated in FIG. 23, when the producer operates the user terminal 300, activates the composition function such as the DAW (Step S111), and selects the creation of the style information (Step S112), composition start information indicating the start of composition is transmitted from the user terminal 300 (Step S113). Then, upon receiving the composition start information, the information processing apparatus 200 transmits information necessary for composition (Step S114).

Subsequently, the user terminal 300 registers the drum pattern (for example, tempo, number of bars, and beat position of Hight Hat, Bass Drumus, Snare) by the operation by the producer according to a UI instruction (Step S115). When Step S115 ends, the user terminal 300 registers the chord progression according to the operation of the producer (Step S116).

After the end of Step S116, a composition function app automatically performs the drum and chord progressions, and accordingly, the producer inputs the melody to the user terminal 300 a plurality of times. With this input operation, the user terminal 300 registers the input melody (Step S117). The user may additionally input the lyric information using the composition function. The user terminal 300 continues the melody registration until the input of the melody by the user ends. When the registration of the melody by the user ends (Step S118), the user terminal 300 transmits the music information by the producer to the information processing apparatus 200 (Step S119). The music information includes feature amounts such as a drum pattern, a chord progression, and a melody.

The information processing apparatus 200 extracts each feature amount included in the music information to generate the score information and the lyric information, and generates the style palette information from the score information and the lyric information (Step S120).

Then, the information processing apparatus 200 obtains each piece of style palette sequence information of the music information, and generates the style information 700 by associating the style information ID with the score information, the lyric information, the style palette information, and the style palette sequence information (Step S121).

The information processing apparatus 200 registers the style information 700 in the style information storage unit 222 (Step S122). At the same time, the information processing apparatus 200 registers data in which the style information ID and the user ID of the producer are associated with each other in the owned information storage unit 223. Then, the information processing apparatus 200 registers data in which the score ID and the user ID of the producer are associated with each other in the production information storage unit 224, and ends the style information generation processing. Note that the style palette sequence information may be generated by the producer arranging a plurality of pieces of style palette information using the composition function.

By executing the processing of FIGS. 22 and 23, the plurality of pieces of style information 700 is accumulated in the information processing apparatus 200. The user such as the producer can select a desired piece of style information from among the pieces of style information and use the automatic composition.

[1-6-3. Processing of Updating Style Information]

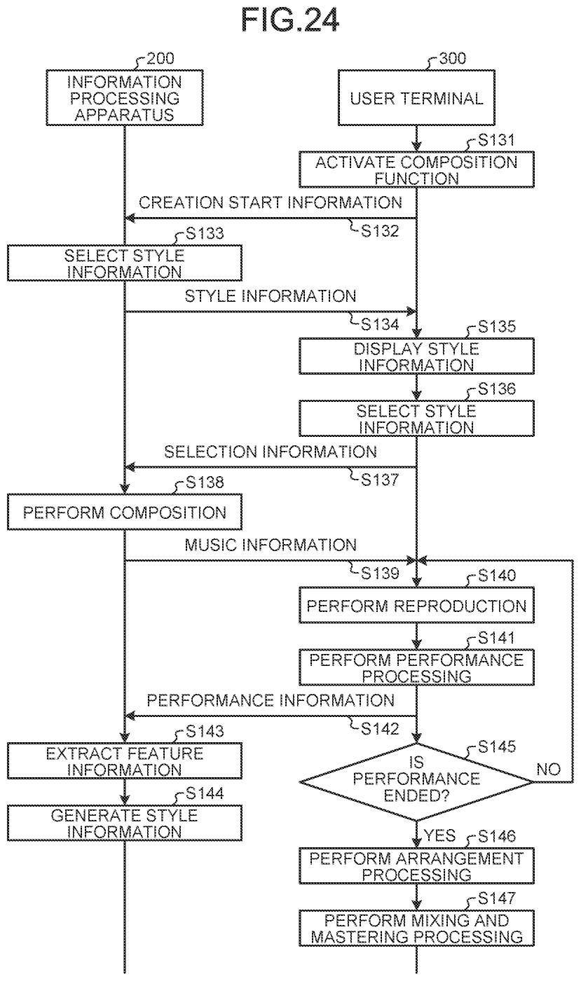

The style information can also be updated by the producer. Therefore, the processing of generating the style information regarding the music information created by the producer will be described with reference to FIG. 24. FIG. 24 is a sequence diagram illustrating a procedure of information processing according to the embodiment.

Upon receiving the composition start information (Step S132) in accordance with the activation of the automatic composition function on the user terminal 300 by the producer (Step S131), the information processing apparatus 200 selects the style information (Step S133) and transmits the presentation information of the style information to the user terminal 300 (Step S134). For example, the information processing apparatus 200 selects all the style information, the style information in which the number of times of use by the producer exceeds a predetermined number of times, or the style information in which the number of times of use by all the users exceeds a predetermined number of times from the style information storage unit 222, and transmits the presentation information of the selected style information.

Then, the user terminal 300 displays a list of the style information on the basis of the presentation information (Step S135). For example, the user terminal 300 displays a list of chord progressions of the style information as candidates. Then, in the user terminal 300, when the style information is selected by the producer (Step S136), selection information indicating the selected style information is transmitted to the information processing apparatus 200 (Step S137).

The information processing apparatus 200 extracts the selected style information, performs machine learning using the extracted style information as learning data and performs the composition processing (Step S138), and provides the music information to the user terminal 300 (Step S139). Note that the information processing apparatus 200 extracts feature amounts of the composed music information by the extraction unit 232, stores new score information including the feature amounts in the storage unit 220, and registers the new score information in the owned information storage unit 223.

When reproducing the provided music (Step S140), the user terminal 300 receives performance processing (Step S141). In a case where the producer performs a performance, for example, using a MIDI keyboard, the performance information is MIDI information. When receiving the transmission of the performance information (Step S142), the information processing apparatus 200 extracts feature amounts from the performance information (Step S143).

The information processing apparatus 200 updates the style information by adding the feature amounts extracted from the performance information as the score information to the style information selected by the producer (Step S144). Thus, since the actual performance by the producer is added to the style information selected by the producer, the music information automatically composed using the style information approaches the style of the producer. That is, the style information can be brought close to the style of the producer who has performed the music. The processing of Steps S140 to S142 is repeated until the producer ends the performance. Then, the score information generated in the repeating process of Steps S140 to S142 repeated until the music is completed is stored in the storage unit 220.

Thus, with the information processing system 1, since the actual performance by the producer is added to the style information selected by the producer, the music information automatically composed using the style information approaches the style of the producer. That is, with the information processing system 1, the style information can be brought close to the style of the producer who has performed the music.

Then, when the performance by the producer ends (Step S145: Yes), the producer may operate the user terminal 300 to perform, for example, arrangement processing (Step S146) and mixing and mastering processing (Step S147).

[1-7. Conceptual Diagram of Configuration of the Information Processing System]

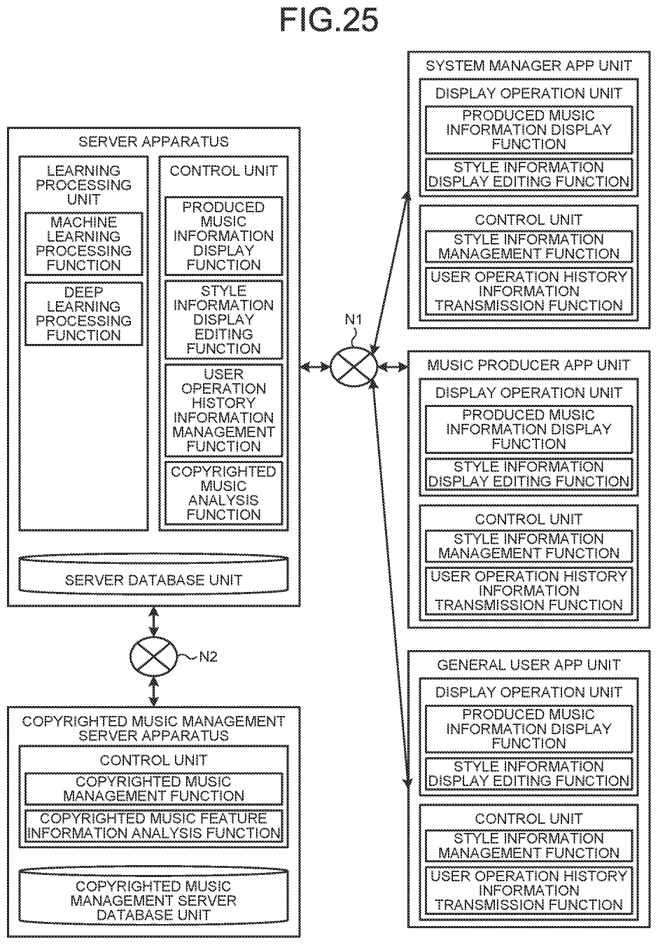

Here, each function, a hardware configuration, and data in the information processing system will be conceptually described with reference to FIG. 25. FIG. 25 is a diagram illustrating an example of a conceptual diagram of a configuration of the information processing system. Specifically, FIG. 25 is a schematic diagram illustrating a functional outline of a system that is an example of applying the information processing system 1.

[1-7-1. Regarding Overall Configuration]

The copyrighted music management server apparatus illustrated in FIG. 25 corresponds to the copyrighted work management apparatus 100 in the information processing system 1. The server apparatus illustrated in FIG. 25 corresponds to the information processing apparatus 200 in the information processing system 1. In addition, a system manager app unit illustrated in FIG. 25 corresponds to an app installed in a terminal used by the system manager. In addition, a producer app unit illustrated in FIG. 25 corresponds to an app installed in the user terminal 300 in the information processing system 1. In addition, a general user app unit illustrated in FIG. 25 corresponds to an app installed in a terminal used by the general user. In the example of FIG. 25, one system manager app unit, one music producer app unit, and one general user app unit are illustrated, but a plurality of these may be included depending on the number of corresponding terminals.

A control unit of the copyrighted music management server apparatus illustrated in FIG. 25 corresponds to the control unit 130 of the copyrighted work management apparatus 100. For example, a copyrighted music management unit of the copyrighted music management server apparatus corresponds to the management unit 131 of the copyrighted work management apparatus 100. A copyrighted music feature information analysis function of the copyrighted music management server apparatus corresponds to the extraction unit 132 of the copyrighted work management apparatus 100. A copyrighted music management server database unit of the copyrighted music management server apparatus corresponds to the storage unit 120 of the copyrighted work management apparatus 100.

A learning processing unit and a control unit of the server apparatus illustrated in FIG. 25 correspond to the control unit 230 of the information processing apparatus 200. For example, the learning processing unit of the server apparatus corresponds to the composition unit 237 of the information processing apparatus 200. The server database unit of the server apparatus corresponds to the storage unit 220 of the information processing apparatus 200.

A display operation unit and a control unit of the music producer app unit illustrated in FIG. 25 correspond to the control unit 350 of the user terminal 300. For example, the display operation unit of the music producer app unit corresponds to the display control unit 351 of the user terminal 300. Display operation units and control units of the system manager app unit and the general user app unit correspond to the control unit of the terminal apparatus used by each user.

As illustrated in FIG. 25, the server apparatus is connected to the system manager app unit, the music producer app unit, and the general user app unit via the network N1 such as the Internet. In addition, the server apparatus is connected to the copyrighted music management server apparatus via the private network N2.

[1-7-2. Regarding Copyrighted Music Management Server Apparatus]

First, a configuration related to the copyrighted music management server apparatus will be described.

The copyrighted music management server apparatus includes the control unit and the copyrighted music management server database unit. The control unit of the copyrighted music management server apparatus includes a copyrighted music management function and the copyrighted music feature information analysis function.

[1-7-3. Regarding Server Apparatus]

First, a configuration related to the server apparatus will be described.

The server apparatus includes the control unit, the learning processing unit, and the server database unit. The control unit of the server apparatus has a produced music information management function, a style information management function, a user operation history information management function, and a copyrighted music analysis function. The learning processing unit of the server apparatus has a machine learning processing function and a deep learning processing function.

[1-7-4. Regarding Music Producer App Unit]

Next, a configuration related to the music producer app unit will be described.

The music producer app unit includes the display operation unit and the control unit. The display operation unit of the music producer app unit has a produced music information display function and a style information display editing function. The music producer app unit has a style information share function and a user operation history information transmission function.

The music producer app unit is, for example, music editing software (DAW or the like), and can display, for example, music information by the produced music information display function. When the DAW has, for example, an AI-assisted music production function, new music information can be produced using a learning model information display editing function. The system manager app unit and the general user app unit have the same configuration, and the authority of the user with respect to the system is different.

[1-8. UI (User Interface)]

Here, details of the automatic composition function including information display by an app (music creation app) will be described with reference to FIGS. 26 and 27. FIGS. 26 and 27 are diagrams illustrating an example of a user interface according to the embodiment.

FIG. 26 illustrates an example of a user interface when the music creation app is displayed on the screen of the user terminal 300.

In the example illustrated in FIG. 26, a user interface IF11 displays music data received by the music creation app. Note that, although details will be described below, the music data in the music creation app includes three types of different data: a melody, a chord, and a bass sound. The user interface IF11 illustrated in FIG. 26 displays data related to a melody among the three types of different data.

Setting information ST11 displays information regarding the style palette, which is an example of the setting information in the automatic composition function. The style palette is designation information for designating style information that becomes learning data of machine learning.

Setting information ST12 displays information regarding harmony, which is an example of the setting information in the automatic composition function. The information regarding harmony is, for example, information for determining a probability that a constituent sound included in a chord appears in a melody in music data composed by the information processing apparatus 200. For example, when the user sets the information regarding harmony to “strict”, the probability that the constituent sound included in the chord appears in the melody in the automatically composed music data increases. On the other hand, when the user sets the information regarding harmony to “loose”, the probability that the constituent sound included in the chord appears in the melody in the automatically composed music data decreases. The example of FIG. 26 indicates that the user applies the information regarding harmony to “strict”.

Setting information ST13 displays note duration information, which is an example of the setting information in the automatic composition function. The note duration information is, for example, information for determining the note duration in the music data composed by the information processing apparatus 200. For example, when the user sets the note duration information to “long”, the probability that a note having a relatively long length of a sound to be made (for example, a whole note, a half note, or the like) appears in the automatically composed music data increases. On the other hand, when the user sets the note duration information to “short”, the probability that a note having a relatively short length of a sound to be made (for example, an eighth note, a sixteenth note, or the like) appears in the automatically composed music data increases.

Setting information ST14 displays information for determining the type and amount of material music other than material music included in the designation information (the style palette designated by the user), which is an example of the setting information in the automatic composition function. Such information is, for example, information for determining whether or not to strictly perform learning on the basis of music included in a style palette designated by the user in the music data composed by the information processing apparatus 200. For example, when the user sets such information to “never”, music other than music included in the style palette is less likely to be used in the learning in the automatic composition. On the other hand, when the user sets such information to “only”, music other than music included in the style palette is more likely to be used in the learning in the automatic composition.

Music data MDT1 displays specific music data transmitted from the information processing apparatus 200. In the example of FIG. 26, the music data MDT1 includes information indicating a chord progression such as of Cm, information indicating a pitch or note duration in a bar, transition of the pitch of a note (in other words, a melody), and the like. In addition, as illustrated in FIG. 26, the music data MDT1 may include, for example, four types of different contents. That is, the information processing apparatus 200 may transmit a plurality of pieces of music data instead of transmitting only one type of automatically composed music data. Thus, the user can select its favorite music data from a plurality of generated music data candidates or compose a favorite music by combining a plurality of pieces of music data.

Note that the user interface IF11 illustrated in FIG. 26 displays data related to a melody among the three types of different data: the melody, the chord, and the bass sound included in the music data, and other data is displayed on another user interface. This point will be described with reference to FIG. 27.

As illustrated in FIG. 27, in addition to the user interface IF11 that displays the data related to the melody, the user terminal 300 may display a user interface IF12 that displays the data related to the chord and a user interface IF13 that displays the data related to the bass sound on the screen. Although not illustrated in FIG. 27, note information different from the music data MDT1 in the user interface IF11 is displayed on the user interface IF12 or the user interface IF13. Specifically, note information (for example, the constituent sound or the like of Cm chord) related to a chord corresponding to the melody of music data is displayed on the user interface IF12. In addition, note information (for example, in the case of Cm chord, “C” sound or the like) related to a bass sound corresponding to the melody or chord of music data is displayed on the user interface IF13.

The user can select information to be copied from the displayed user interface IF11, user interface IF12, and user interface IF13, and perform work such as editing a part of the bass sound.

### 2. Effects According to the Present Embodiment

As described above, the information processing apparatus (the information processing apparatus 200 in the embodiment) according to the present embodiment includes the acquisition unit (the acquisition unit 231 in the embodiment), the extraction unit (the extraction unit 232 in the embodiment), and the generation unit (the generation unit 233 in the embodiment). The acquisition unit acquires the music information. The extraction unit extracts a plurality of types of feature amounts from the music information acquired by the acquisition unit. The generation unit generates information in which the plurality of types of feature amounts extracted by the extraction unit is associated with predetermined identification information as music feature information (style information in the embodiment) used as learning data in the composition processing using machine learning.

As described above, the information processing apparatus according to the present embodiment can generate the style information having the plurality of types of feature amounts of the music information as a learning data set of the composition model. The information processing apparatus according to the present embodiment causes the composition model to learn the style information, so that the music information composed in accordance with the features of the music can be provided to each user including the producer. Therefore, the information processing apparatus according to the present embodiment can improve convenience of the music creation function by the user.

In addition, the acquisition unit acquires the music information by receiving, from the terminal apparatus (the user terminal 300 in the embodiment), the music information including the feature amounts related to the music created by the producer using the music creation-related application installed in the terminal apparatus. The extraction unit extracts a plurality of types of feature amounts included in the music information. The generation unit associates the identification information of the producer with the music feature information. Thus, the information processing apparatus can generate the music feature information regarding the music information created by the producer.

In addition, the feature amounts related to the music created by the producer are the chord progression information indicating the chord progression, the melody information indicating the melody, and a bass signal indicating the bass progression in a bar having a prescribed length. Therefore, regarding the music information created by the producer, since the information processing apparatus can generate the music feature information using the feature amounts related to the music created by the producer, the music feature information can be quickly generated.

In addition, the feature amount related to the music created by the producer is drum progression information indicating the drum progression in a bar having a prescribed length. Therefore, the information processing apparatus can generate the music feature information including the drum progression information.

In addition, the acquisition unit acquires the periodically registered copyrighted music information at a preset timing. The extraction unit extracts a plurality of types of feature amounts from the copyrighted music information. The generation unit associates the identification information of the copyrighted music information with the style information. Thus, the information processing apparatus 200 can automatically generate the music feature information regarding the periodically registered copyrighted music information.

In addition, the information processing apparatus includes the transmission unit (the transmission unit 236 in the embodiment) that transmits the presentation information of the music feature information according to the instruction information received from the terminal apparatus in which the music creation-related application is installed. The information processing apparatus includes the composition unit (the composition unit 237 in the embodiment) that, when receiving selection of the music feature information from the terminal apparatus, composes music information using machine learning on the basis of the selected feature information, and transmits the composed music information to the terminal apparatus. Thus, the information processing apparatus presents the music feature information corresponding to the instruction information to the terminal apparatus, so that the producer can select desired music feature information from the music feature information. Then, the information processing apparatus can provide the music information composed on the basis of the music feature information desired by the producer.

In addition, the information processing apparatus further includes the update unit (the update unit 238 in the embodiment) that, when receiving performance information based on the music information transmitted by the composition unit from the terminal apparatus, adds the performance information to the selected music feature information and updates the selected music feature information. Thus, the information processing apparatus can bring the music feature information closer to the style of the producer who performed the music by adding the performance information by the producer to the selected music feature information.

In addition, the extraction unit extracts, from the music information, the chord progression information indicating the chord progression, the melody information indicating the melody, and the bass information indicating the bass progression in a bar having a prescribed length as the feature amounts. The generation unit generates score information including the chord progression information indicating the chord progression, the melody information indicating the melody, and the bass information indicating the bass sound progression in a bar having a prescribed length, and sets the score information as a component of the music feature information. Thus, the information processing apparatus can generate the music feature information including the chord progression information, the melody information, and the bass information. Then, at the time of composition, the information processing apparatus learns the feature amounts such as the chord progression information, the melody information, and the bass information instead of the music information itself, so that the music information can be efficiently provided to the user.

The extraction unit extracts, from the music information, the drum information indicating the drum sound progression in a bar having a prescribed length as the feature amount. The generation unit further adds drum progression information to the score information. Thus, the information processing apparatus can generate the music feature information including the chord progression information, the melody information, the bass information, and the drum information.

The generation unit generates the lyric information indicating the lyrics in a bar having a prescribed length from lyric information added to the music information, and sets the lyric information as a component of the music feature information. Thus, in a case where the terminal apparatus searches for lyrics, since the information processing apparatus can extract the music feature information including the lyrics or lyrics similar to the lyrics and present the music feature information to the terminal apparatus, the convenience of the music creation function by the user can be improved. In addition, the information processing apparatus can automatically generate lyrics.

The generation unit generates music format information in which the identification information of the score information and the identification information of the lyric information for the same bar are registered in association with each other, and sets the music format information as a component of the music feature information. The information processing apparatus can further provide music information desired by the user by learning the music feature information.

The generation unit adds and registers the identification information of score information having chord progression information similar to the chord progression information of the score information registered in the music format information to the music format information. Thus, the information processing apparatus can compose music information along the structure of music.

The generation unit generates music order information indicating the order of the music format information and sets the music order information as a component of the music feature information. Since the information processing apparatus can also learn the order of the music format information, the learning accuracy can be further improved.

### 3. Other Embodiment

The processing according to the embodiment and variation described above may be performed in various different forms (variations) other than the embodiment and variation described above.

### 3-1. Other Configuration Example

Each of the above-described configurations is an example, and the information processing system 1 may be any system configuration as long as the above-described information processing can be realized. For example, the copyrighted work management apparatus 100 and the information processing apparatus 200 may be integrated.

### 3-2. Others

In addition, among the pieces of processing described in each of the above embodiments, all or some of the pieces of processing described as being performed automatically can be performed manually, or all or some of the pieces of processing described as being performed manually can be performed automatically by a known method. In addition, the processing procedures, the specific names, and the information including various data and parameters indicated in the document and the drawings can be arbitrarily changed unless otherwise specified. For example, the various information illustrated in each drawing is not limited to the illustrated information.

In addition, each component of each apparatus illustrated in the drawings is functionally conceptual, and is not necessarily physically configured as illustrated in the drawings. That is, a specific form of distribution and integration of apparatuses is not limited to those illustrated, and all or a part thereof can be functionally or physically distributed and integrated in an arbitrary unit according to various loads, usage situations, and the like.

In addition, the above-described embodiments and variation can be appropriately combined within a range not contradicting processing contents.

In addition, the effects described in the present specification are merely examples and are not limitative, and there may be other effects.

### 4. Hardware Configuration

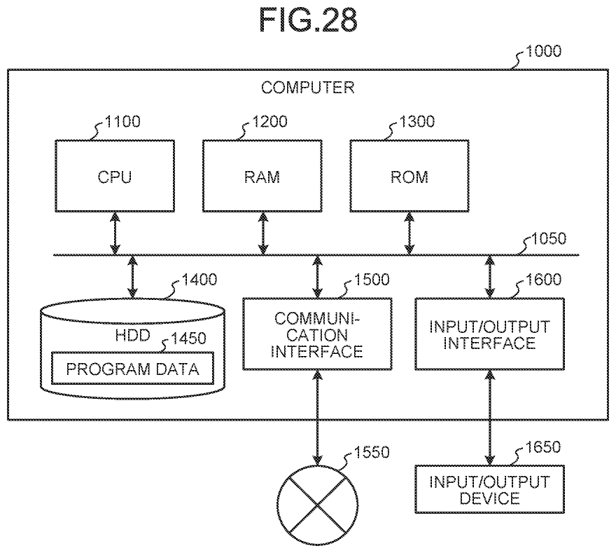

The information devices such as the information processing apparatus 200, the copyrighted work management apparatus 100, the user terminal 300, or the like according to the embodiments and variation described above are realized by a computer 1000 having a configuration as illustrated, for example, in FIG. 28. FIG. 28 is a hardware configuration diagram illustrating an example of the computer 1000 that implements the functions of the information processing apparatus 200, the copyrighted work management apparatus 100, and the user terminal 300. Hereinafter, the information processing apparatus 200 according to the embodiment will be described as an example. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 loads the program stored in the ROM 1300 or the HDD 1400 to the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure, which is an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, a printer, or the like via the input/output interface 1600. In addition, the input/output interface 1600 may function as a media interface that reads a program or the like recorded in a predetermined recording medium (medium). The medium is, for example, an optical recording medium such as a digital versatile disc (DVD), phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 200 according to the embodiment, the CPU 1100 of the computer 1000 executes an information processing program loaded on the RAM 1200 to realize the functions of the control unit 130 and the like. In addition, the HDD 1400 stores an information processing program according to the present disclosure and data in the storage unit 120. Note that the CPU 1100 reads the program data 1450 from the HDD 1400 and executes the program data, but as another example, these programs may be acquired from another apparatus via the external network 1550.

Note that the present technology can also have the following configurations.

(1)

An information processing apparatus comprising:

an acquisition unit that acquires music information;

an extraction unit that extracts a plurality of types of feature amounts from the music information acquired by the acquisition unit; and

a generation unit that generates information in which the plurality of types of feature amounts extracted by the extraction unit is associated with predetermined identification information as music feature information to be used as learning data in composition processing using machine learning.

(2)

The information processing apparatus according to (1), wherein

the acquisition unit acquires music information by receiving music information created by a producer using a music creation-related application installed in a terminal apparatus from the terminal apparatus,

the extraction unit extracts the plurality of types of feature amounts included in the music information, and

the generation unit associates identification information of the producer with the music feature information.

(3)

The information processing apparatus according to (2), wherein the music information created by the producer includes chord progression information indicating a chord progression, melody information indicating a melody, and a bass signal indicating a bass progression in a bar having a prescribed length.

(4)

The information processing apparatus according to (3), wherein the music information created by the producer includes drum progression information indicating a drum progression in a bar having a prescribed length.

(5)

The information processing apparatus according to (1), wherein

the acquisition unit acquires copyrighted music information that is periodically registered at a preset timing,

the extraction unit extracts the plurality of types of feature amounts from the copyrighted music information, and

the generation unit associates identification information of the copyrighted music information with the music feature information.

(6)

The information processing apparatus according to (1), further comprising:

a transmission unit that transmits presentation information of the music feature information according to instruction information received from a terminal apparatus in which a music creation-related application is installed; and

a composition unit that, upon receiving selection of the music feature information from the terminal apparatus, composes music information using machine learning on a basis of the selected music feature information and transmits the composed music information to the terminal apparatus.

(7)

The information processing apparatus according to (6), further comprising:

an update unit that, when receiving performance information based on the music information transmitted by the composition unit from the terminal apparatus, adds the performance information to the selected music feature information and updates the selected music feature information.

(8)

The information processing apparatus according to (1), wherein

the extraction unit extracts, from the music information, chord progression information indicating a chord progression, melody information indicating a melody, and a bass signal indicating a bass progression in a bar having a prescribed length as feature amounts, and

the generation unit generates score information including chord progression information indicating a chord progression, melody information indicating a melody, and bass information indicating a bass sound progression in the bar having the prescribed length, and sets the score information as a component of the music feature information.

(9)

The information processing apparatus according to (8), wherein

the extraction unit extracts, from the music information, drum information indicating a drum sound progression in the bar having the prescribed length as a feature amount, and

the generation unit further adds the drum information to the score information.

(10)

The information processing apparatus according to (8), wherein the generation unit generates lyric information indicating lyrics in the bar having the prescribed length from lyric information added to the music information, and sets the lyric information as a component of the music feature information.

(11)

The information processing apparatus according to (10), wherein the generation unit generates music format information in which identification information of the score information and identification information of the lyric information for a same bar are registered in association with each other, and sets the music format information as a component of the music feature information.

(12)

The information processing apparatus according to (11), wherein the generation unit adds and registers identification information of score information having chord progression information similar to the chord progression information of the score information registered in the music format information to the music format information.

(13)

The information processing apparatus according to (11), wherein the generation unit generates music order information indicating an order of the music format information and sets the music order information as a component of the music feature information.

(14)

An information processing method executed by a computer, the method comprising:

acquiring music information;

extracting a plurality of types of feature amounts from the music information acquired; and

generating information in which the plurality of types of feature amounts extracted is associated with predetermined identification information as music feature information to be used in composition processing using machine learning.

(15)

An information processing program causing a computer to:

acquire music information;

extract a plurality of types of feature amounts from the music information acquired; and

generate information in which the plurality of types of feature amounts extracted is associated with predetermined identification information as music feature information to be used in composition processing using machine learning.

### REFERENCE SIGNS LIST

1 INFORMATION PROCESSING SYSTEM
100 COPYRIGHTED WORK MANAGEMENT APPARATUS
110, 210, 310 COMMUNICATION UNIT
120, 220, 340 STORAGE UNIT
130, 230, 350 CONTROL UNIT
121 COPYRIGHTED MUSIC INFORMATION STORAGE UNIT
122 MUSIC STORAGE UNIT
123 FEATURE INFORMATION STORAGE UNIT
131 MANAGEMENT UNIT
132 EXTRACTION UNIT
133 TRANSMISSION UNIT
200 INFORMATION PROCESSING APPARATUS
221 USER INFORMATION STORAGE UNIT
222 STYLE INFORMATION STORAGE UNIT
223 OWNED INFORMATION STORAGE UNIT
224 PRODUCTION INFORMATION STORAGE UNIT
225 OPERATION HISTORY INFORMATION STORAGE UNIT
231 ACQUISITION UNIT
232 EXTRACTION UNIT
233 GENERATION UNIT
234 RECEPTION UNIT
235 SELECTION UNIT
236 TRANSMISSION UNIT
237 COMPOSITION UNIT
238 UPDATE UNIT
300 USER TERMINAL
320 INPUT UNIT
330 OUTPUT UNIT
351 DISPLAY CONTROL UNIT
352 REGISTRATION UNIT
353 TRANSMISSION/RECEPTION UNIT
354 SELECTION UNIT
355 REPRODUCTION UNIT
356 PERFORMANCE RECEPTION UNIT
360 DISPLAY UNIT

1. An information processing apparatus comprising:
an acquisition unit that acquires music information;
an extraction unit that extracts a plurality of types of feature amounts from the music information acquired by the acquisition unit; and
a generation unit that generates information in which the plurality of types of feature amounts extracted by the extraction unit is associated with predetermined identification information as music feature information to be used as learning data in composition processing using machine learning.

2. The information processing apparatus according to claim 1, wherein
the acquisition unit acquires music information by receiving music information created by a producer using a music creation-related application installed in a terminal apparatus from the terminal apparatus,
the extraction unit extracts the plurality of types of feature amounts included in the music information, and
the generation unit associates identification information of the producer with the music feature information.

3. The information processing apparatus according to claim 2, wherein the music information created by the producer includes chord progression information indicating a chord progression, melody information indicating a melody, and a bass signal indicating a bass progression in a bar having a prescribed length.

4. The information processing apparatus according to claim 3, wherein the music information created by the producer includes drum progression information indicating a drum progression in a bar having a prescribed length.

5. The information processing apparatus according to claim 1, wherein
the acquisition unit acquires copyrighted music information that is periodically registered at a preset timing,
the extraction unit extracts the plurality of types of feature amounts from the copyrighted music information, and
the generation unit associates identification information of the copyrighted music information with the music feature information.

6. The information processing apparatus according to claim 1, further comprising:
a transmission unit that transmits presentation information of the music feature information according to instruction information received from a terminal apparatus in which a music creation-related application is installed; and
a composition unit that, upon receiving selection of the music feature information from the terminal apparatus, composes music information using machine learning on a basis of the selected music feature information and transmits the composed music information to the terminal apparatus.

7. The information processing apparatus according to claim 6, further comprising:
an update unit that, when receiving performance information based on the music information transmitted by the composition unit from the terminal apparatus, adds the performance information to the selected music feature information and updates the selected music feature information.

8. The information processing apparatus according to claim 1, wherein
the extraction unit extracts, from the music information, chord progression information indicating a chord progression, melody information indicating a melody, and a bass signal indicating a bass progression in a bar having a prescribed length as feature amounts, and
the generation unit generates score information including chord progression information indicating a chord progression, melody information indicating a melody, and bass information indicating a bass sound progression in the bar having the prescribed length, and sets the score information as a component of the music feature information.

9. The information processing apparatus according to claim 8, wherein
the extraction unit extracts, from the music information, drum information indicating a drum sound progression in the bar having the prescribed length as a feature amount, and
the generation unit further adds the drum information to the score information.

10. The information processing apparatus according to claim 8, wherein the generation unit generates lyric information indicating lyrics in the bar having the prescribed length from lyric information added to the music information, and sets the lyric information as a component of the music feature information.

11. The information processing apparatus according to claim 10, wherein the generation unit generates music format information in which identification information of the score information and identification information of the lyric information for a same bar are registered in association with each other, and sets the music format information as a component of the music feature information.

12. The information processing apparatus according to claim 11, wherein the generation unit adds and registers identification information of score information having chord progression information similar to the chord progression information of the score information registered in the music format information to the music format information.

13. The information processing apparatus according to claim 11, wherein the generation unit generates music order information indicating an order of the music format information and sets the music order information as a component of the music feature information.

14. An information processing method executed by a computer, the method comprising:
acquiring music information;
extracting a plurality of types of feature amounts from the music information acquired; and
generating information in which the plurality of types of feature amounts extracted is associated with predetermined identification information as music feature information to be used in composition processing using machine learning.

15. An information processing program causing a computer to:
acquire music information;
extract a plurality of types of feature amounts from the music information acquired; and
generate information in which the plurality of types of feature amounts extracted is associated with predetermined identification information as music feature information to be used in composition processing using machine learning.
